(19) United States
(12) Patent Application Publication
(10) Pub. No.: US 2010/0211661 A1
(43) Pub. Date: Aug. 19, 2010

(54) ADDRESS GENERATION METHOD, ADDRESS GENERATION SYSTEM, COMMUNICATION DEVICE, COMMUNICATION METHOD, COMMUNICATION SYSTEM, AND PARTNER COMMUNICATION DEVICE

(75) Inventors: Tetsuro Morimoto, Osaka (JP); Takashi Aramaki, Osaka (JP)

Correspondence Address: Dickinson Wright PLLC;James E. Ledbetter, Esq., International Square, 1875 Eye Street, N.W., Suite 1200, Washington, DC, 20006, US

(73) Assignee: PANASONIC CORPORATION, Osaka (JP)

(21) Appl. No.: 12/669,155

(22) PCT Filed: Jul. 14, 2008
(86) PCT No.: PCT/JP2008/001884

§ 371 Date: Jan. 15, 2010

(30) Foreign Application Priority Data
Jul. 18, 2007 (JP) 2007-186982
Nov. 15, 2007 (JP) 2007-296863

(51) Int. Cl. G06F 15/177; G06F 15/173

(52) U.S. Cl. 709/222; 709/242

(57) ABSTRACT

Disclosed is a technique allowing a transmission-end of data and a message to confirm a destination address in a transmission request from a reception-end so as to prevent an attack by a transmission request from an unauthorized third person. According to the technique, (1) MN1 transmits a HoTI message to CN2 via HA3, (2) CN2 transmits a HoT message to MN1 via HA3 in response to the HoTI message, (3) MN1 generates CoA from Home Token in the HoT message, and transmits a CoTIβ including CoA to CN2, and (4) CN2 compares CoA in the CoTIβ message with CoA generated from Home Token in the Hot message transmitted to MN1.

### TECHNICAL FIELD

The present invention relates to an address generation method, an address generation system, and a node that prevent an attack by a transmission request from an unauthorized third person.

The present invention particularly relates to a communication method, a communication system, a node and a correspondent node that, when an address test request-side node has a plurality of addresses, a request message can include a destination of a response message therein, and a source address from which the request message is transmitted and a reception address of a response message in response to the request message are different, prevent an attack by a transmission request from an unauthorized third person.

### BACKGROUND ART

Conventionally in a protocol using an IP network, when a request-side node transmits a request message to a response-side node to request a message or data and the response-side node transmits a response message to the request-side node, a source address of the request message and a destination address of the response message are normally the same. However, another usage is becoming used to let one node have a plurality of communication interfaces, allocating a different address to each communication interface or allocating a plurality of addresses to even one communication interface. In such a situation, it is considered that a communication method using different addresses for a source address of a request message and a destination address of a response message will be often used.

If the mutual usage of a communication network and a broadcasting network is developed, a further possible environment is such that a communication network route enabling two-way (bidirectional) communication and a broadcasting network route enabling only one-way communication are mixed. In such a case, when attempt is made to use the only one-way communicable route effectively, since a message can flow in the only one direction, both of the request message and the response message cannot flow in the same route, resulting in the state where only one of the request message and the response message flows in this one-way route. That is, there may be a case where a source address of the request message and a destination address of the response message are different.

When the source address of the request message and the destination address of the response message are different, they may be exploited as denial of service attack. Especially in the case of adopting a method to include a destination address of a response message in a request message, an attacker can easily send a message unnecessary for a target from the response-side node to the target by setting a target address as a source address of the request message and transmitting the request message to the response-side node.

The present invention provides a technique to cope with this problem. The present specification describes in detail a conventional technique and a problem that the conventional technique cannot solve, particularly by way of an example where a route optimization (Non-Patent Document 1 described later) of Mobile IP is expanded applicable to a one-way route.

<Binding Update and Return Routability Procedure of Mobile IP>

Conventionally, Mobile IP is available as a technique allowing, even after a node moves, the same IP address to be used continuously as that before the movement. According to Mobile IP, a home agent (hereinafter may called HA) receives a packet addressed to a home address (hereinafter may called HoA) of a mobile node (hereinafter may called MN) and transfers the same to a care-of address (hereinafter may called CoA, further this may be called a routable address while visiting a foreign link also in this specification). Thus, the mobile node can continue a communication using a home address regardless of an address change due to the movement.

Further, in order to alleviate the detouring of a communication route between a mobile node and a correspondent node (hereinafter may called CN) resulting from a packet passing through the home agent, a route optimization technique exists that directly connects a communication route of the mobile node and the correspondent node. This route optimization technique makes the correspondent node store a correspondence between the home address and the care-of address of the mobile node, thus enabling a communication using the care-of address. This procedure of making the correspondent node store the correspondence between the home address and the care-of address of the mobile node is called Binding Update (hereinafter may called BU).

In binding update for the correspondent node, a return routability procedure is required, unlike the binding update for a home agent. A trust relationship can be established in advance between the home agent and the mobile node, and therefore there is no need to conduct this return routability procedure. This is because, in binding update for a home agent, when a mobile node notifies the home agent of a new care-of address for the home address, the home agent can understand based on a trust relationship (IPsec SA (Security Association) or the like) that has been established in advance that a binding update request is made from the mobile node.

On the other hand, it is difficult for the correspondent node to establish a trust relationship with every node that might be connected therewith before binding update. If the correspondent node accepts a binding update request without any trust relationship therebetween, an attack disguising as a mobile node can be made easily. The return routability procedure is to prevent this attack. The return routability procedure includes a home address test procedure (Home Test, hereinafter may called HoT) and a care-of address test procedure (Care-of Test, hereinafter may be called COT). The home address test confirms that transmission and reception can be carried out using a home address and the care-of address test confirms that transmission and reception can be carried out using a care-of address, thus preventing an unauthorized binding update. As for Mobile IP, the route optimization, and the return routability procedure described above as the conventional technique are mentioned in RFC3775 (the following Non-Patent Document 1). The design concept of the return routability procedure is mentioned in RFC4225 (the following Non-Patent Document 2):

Non-Patent Document 1: RFC3775 “Mobility Support in IPv6”,

Non-Patent Document 2: RFC4225 “Mobile IP Version 6 Route Optimization Security Design Background”.

<Adaptation of Mobile IP Route Optimization to One-Way Route>

The Mobile IP route optimization technique, however, cannot be used for an asymmetric network. Since two-way reachability is required for the route optimization, the binding update procedure cannot be conducted in a route where data flows asymmetrically in one way only like in satellite broadcasting or digital television broadcasting.

For instance, in the case where communication can be made only in the direction from the mobile node to the correspondent node, a BU (Binding Update) message reaches the correspondent node but a BA (Binding Acknowledgement) message does not reach the mobile node. Thus, the mobile node fails in binding update for the correspondent node. Further, a CoTI (Care-of Test Init) message to start a care-of address test procedure reaches the correspondent node but a CoT (Care-of Test) message does not reach the mobile node, resulting in a failure to conduct a return routability procedure. Conversely, in the case where communication can be made only in the direction from the correspondent node to the mobile node, the BU message does not reach the correspondent node, and therefore binding update cannot be conducted. Further, the CoTI message does not reach the correspondent node, resulting in a failure to conduct a return routability procedure. In this way, in the case of a route where communication can be made only in one direction, the return routability procedure and the binding update cannot be conducted. Thus, route optimization cannot be conducted using a communicable one-way route.

Herein, as for the one-way communicable case only from the mobile node to the correspondent node and the one-way communicable case only from the correspondent node to the mobile node, the following solutions (1) and (2) can be considered, respectively.

(1) In the one-way communicable case only from the mobile node to the correspondent node, an authentication code is added to a request message CoTI (hereinafter called CoTIα) for a care-of address test procedure using a key generated from a result of a home address test procedure. Receiving this request message CoTIα, the correspondent node checks the authentication code so as to confirm that a sender of this request message CoTIα conducts the home address test procedure. The home address test procedure is for confirming whether transmission/reception is made using a home address (HoA). The correspondent node can confirm based on this authentication code that the mobile node can correctly receive a message transmitted to the home address. Receiving the request message CoTIα for the care-of address test, the correspondent node returns a response message CoT (hereinafter called CoTα). A source address of the request message CoTIα is a care-of address CoA, and a destination address of the response message is a home address HoA. Although the source address CoA of the request message is different from the destination address HoA of the response message, the authentication code indicating a result of the home address test procedure to confirm the transmission/reception using the home address HoA is added to the request message, so that the correspondent node can judge it safe to transmit the response message CoTα to the home address HoA.

(2) Next, in the opposite one-way communicable case from the correspondent node to the mobile node, similarly to the above, an authentication code is added to a request message CoTI (hereinafter called CoTIβ) for a care-of address test procedure using a key generated from a result of a home address test procedure, and further a source address of the request message is added to a response message CoT (hereinafter called CoTβ). A source address of the request message CoTIβ is a home address HoA, and a destination address of the response message CoTβ is a care-of address CoA. Receiving the request message CoTIβ, the correspondent node confirms that the source address of the request message is the home address HoA and further confirms that that is surely the request message CoTI transmitted from the terminal conducting transmission/reception at the home address HoA based on the authentication code included in the request message CoTIβ. This confirmed home address HoA is added to the response message CoTβ, which is transmitted to the care-of address CoA. Even if the response message CoTβ of the care-of address test procedure is transmitted to a third terminal (target) while setting an address of the third terminal (target) as the care-of address CoA with the intention of attacking other terminals, the third terminal (target) can immediately notice that the address of the attacker is HoA. Since the home address test procedure can confirm that the address HoA of the attacker is transmitted/received by the attacker, the attacker can be easily identified, thus leading to an effect of suppressing the exploit as a reflection attack.

The above-stated solutions (1) and (2) prevent setting of unauthorized binding cache and enables route optimization even in one-way route. The solution (2), however, has a possibility that the response message CoTβ is exploited as an attack. One of the two one-way routes having no problem is the one-way route from the mobile node to the correspondent node. In this case, the correspondent node as the response-side node authenticates a response destination address to confirm the same, and then transmits a response message. The home address test procedure has confirmed that the response destination address allows a message to reach a requester.

On the other hand, in the case of the opposite one-way route from the correspondent node to the mobile node, a response destination address has not been confirmed. In the solution (2), attempt is made to suppress the exploit as a reflection attack by including an address of the request message CoTIβ in the response message CoTβ. That is, prevention cannot be made before the transmission of the response message CoTβ.

<Problems Occurring in the Case Other than Adaptation of Mobile IP Route Optimization to One-Way Route>

The above describes the case of adaptation of Mobile IP route optimization to one-way route. However, the above-stated problem may occur in other cases also. That is, when a first node transmits a request message to a second node while designating a destination of a response message in the request message. When the second node transmits a response message to the designated response message destination in the request message, if an attack target exists in the designated destination of the response message, the second node will accordingly transmit an unnecessary message to the target in accordance with the designation from the attacker (the first node). The terminal as the target, whose band is consumed wastefully, is damaged of a denial of service. Although the second node does not intend to attack the target, it is exploited by the attacker to help the attack against the target.

### DISCLOSURE OF THE INVENTION

In view of the above-stated problems of the conventional techniques, it is an object of the present invention to provide an address generation method, an address generation system, a node that makes a transmission-end of data and a message confirm a destination address in a transmission request from a reception-end so as to prevent an attack by a transmission request from an unauthorized third person.

In view of the above-stated problems of the conventional techniques, it is another object of the present invention to provide a communication method, a communication system, a node, and a correspondent node that can implement a return routability procedure enabling route optimization while keeping the same level of safety for a transmission request from an unauthorized third person as in the conventional techniques.

It is still another object of the present invention to provide a communication method, a communication system, a node and a correspondent node that, when an address test request-side node has a plurality of addresses, a request message can include a destination of a response message therein, and a source address from which the request message is sent and a reception address of a response message in response to the request message are different, prevent an attack by a transmission request from an unauthorized third person.

In order to achieve the above-stated objects, an address generation method of the present invention includes the steps of: a step where a second node transmits, to a first node, address generation information allowing the first node to generate a new address; a step where the first node generates the address of the first node based on the address generation information received from the second node and transmits the same to the second node; and a step where the second node compares the address of the first node received from the first node with an address generated based on the address generation information transmitted to the first node.

This configuration allows a transmission-end of data and a message to confirm a destination address in a transmission request from a reception-end so as to prevent an attack by a transmission request from an unauthorized third person.

Further, the first and the second nodes may be a mobile node and a correspondent node thereof, respectively, and the address of the first node may be a care-of address of the mobile node, the address generation method further may include a step of carrying out route optimization between the care-of address of the mobile node and the correspondent node.

With this configuration, a return routability procedure can be conducted, enabling route optimization while keeping the same level of safety for a transmission request from an unauthorized third person as in the conventional techniques. Further, when an address test request-side node has a plurality of addresses, a source address from which a request message is sent and a reception address of a response message in response to the request message are different, and the request message can include a destination of the response message therein, an attack by a transmission request from an unauthorized third person can be prevented.

Further, the address generation information may be home token included in a home address test response message transmitted from the correspondent node to the mobile node in the route optimization step.

This configuration allows a care-of address of a mobile node to be generated without adding special address generation information when conducting the return routability procedure enabling route optimization.

In order to achieve the above-stated objects, an address generation system of the present invention includes: means adapted so that a second node transmits, to a first node, address generation information allowing the first node to generate a new address; means adapted so that the first node generates the address of the first node based on the address generation information received from the second node and transmits the same to the second node; and means adapted so that the second node compares the address of the first node received from the first node with an address generated based on the address generation information transmitted to the first node.

In order to achieve the above-stated objects, a node of the present invention includes: means that receives address generation information to generate a new address from a correspondent node; and means that generates the address based on the address generation information, and transmits, to the correspondent node, information enabling comparison of the address with an address generated by the correspondent node based on the address generation information.

In order to achieve the above-stated objects, a correspondent node of the present invention includes: means that transmits, to a node on one end, address generation information to generate a new address of the node on one end; and means that, when the node on one end generates an address of the node on one end based on the address generation information, receives the address and compares the same with an address generated based on the address generation information transmitted to the node on one end.

In order to achieve the above-stated objects, a communication method of the present invention includes the steps of: an address generation information transmission step where a second node creates address generation information to generate a second address of a first node, and transmits an address generation information message including the address generation information to a first address of the first node; a reply-to address request message transmission step where the first node generates the second address based on the address generation information in the address generation information message, and transmits a reply-to address request message from the first address to the second node, the reply-to address request message designating the second address as a response message destination; and a reply-to address response message transmission step where the second node receives the reply-to address request message, compares the second address in the reply-to address request message with an address generated based on the address generation information, and transmits a reply-to address response message to the second address of the first node.

The address generation information may be generated from secret information that the second node only keeps and a random value that the second node generates at regular intervals. Therefore, the first node cannot expect what address is generated as the second address. Thereby, it is further impossible to conduct a DoS attack.

The address generation information may be home token used for a binding procedure conducted for route optimization in Mobile IP.

The second address may be an address for a one-way route that is exclusively used for reception from the first node.

In order to achieve the above-stated objects, a communication system of the present invention includes: address generation information transmission means adapted so that a second node creates address generation information to generate a second address of a first node, and transmits an address generation information message including the address generation information to a first address of the first node; reply-to address request message transmission means adapted so that the first node generates the second address based on the address generation information in the address generation information message, and transmits a reply-to address request message from the first address to the second node, the reply-to address request message designating the second address as a response message destination; and reply-to address response message transmission means adapted so that the second node receives the reply-to address request message, compares the second address in the reply-to address request message with an address generated based on the address generation information, and transmits a reply-to address response message to the second address of the first node.

In order to achieve the above-stated objects, a node of the present invention includes: means that receives an address generation information message transmitted to a first address, the address generation information message including address generation information that a correspondent node creates to generate a second address; means that generates the second address based on the address generation information in the received address generation information message, and transmits a reply-to address request message from the first address to the correspondent node, the reply-to address request message designating the second address as a response destination; and means that, when the correspondent node compares the second address in the reply-to address request message with an address generated based on the address generation information and transmits a reply-to address response message to the second address, receives the reply-to address response message.

In order to achieve the above-stated objects, a correspondent node of the present invention includes: means that creates address generation information to generate a second address of a node on one end, and transmits an address generation information message including the address generation information to a first address of the node on one end, means that receives, when the node on one end receiving the address generation information message generates the second address based on the address generation information in the address generation information message and transmits a reply-to address request message that designates the second address as a response destination, receives the reply-to address request message; and means that receives the reply-to address request message, compares the second address in the reply-to address request message with an address generated based on the address generation information, and transmits a reply-to address response message to the second address of the node.

According to the present invention, a transmission-end of data and a message can confirm a destination address in a transmission request from a reception-end so as to prevent an attack by a transmission request from an unauthorized third person.

Further, a return routability procedure can be conducted, enabling route optimization while keeping the same level of safety for a transmission request from an unauthorized third person as in the conventional techniques.

Further, when an address test request-side node has a plurality of addresses, a source address from which a request message is sent and a reception address of a response message in response to the request message are different, and the request message can include a destination of the response message therein, an attack by a transmission request from an unauthorized third person can be prevented.

### BRIEF DESCRIPTION OF THE DRAWINGS

FIG. 1 explains the case where in Embodiment 1 of the present invention communication is carried out in a one-way direct route in the direction from a correspondent node to a mobile node.

FIG. 2 explains the case where in Embodiment 1 of the present invention communication is carried out in a one-way direct route and a detour route in the direction from a correspondent node to a mobile node.

FIG. 3 explains exemplary exploit of unauthorized binding cache as an attack.

FIG. 4 explains a binding update method in Mobile IP.

FIG. 5A explains a binding update method in Embodiment 1 of the present invention, illustrating routes of HoTI and HoT messages.

FIG. 5B explains a binding update method in Embodiment 1 of the present invention, illustrating routes of CoTIβ and CoTβ messages.

FIG. 5C explains a binding update method in Embodiment 1 of the present invention, illustrating routes of BUβ and BAβ messages.

FIG. 6 explains an exemplary exploit of a care-of address test procedure as a service attack.

FIG. 7 explains a message sequence in one embodiment of the present invention.

FIG. 8 explains a message sequence in Mobile IP as the conventional technique.

FIG. 9 explains a message format in Mobile IP.

FIG. 10 explains a message sequence in Embodiment 1 of the present invention.

FIG. 11 explains a message format to store Home nonce id in Embodiment 1 of the present invention.

FIG. 12 explains a message format to store prefix length in Embodiment 1 of the present invention.

FIG. 13 explains a message format to store Care-of address in Embodiment 1 of the present invention.

FIG. 14 is a block diagram illustrating the configuration of a correspondent node in Embodiment 1 of the present invention.

FIG. 15 is a block diagram illustrating the configuration of a mobile node in Embodiment 1 of the present invention.

FIG. 16 explains a message sequence in another embodiment of the present invention.

FIG. 17A explains Embodiment 2 of the present invention, illustrating routes of HoTI and HoT messages.

FIG. 17B explains Embodiment 2 of the present invention, illustrating routes of BUβ and BAβ messages.

FIG. 18 explains a message sequence in Embodiment 2 of the present invention.

### BEST MODE FOR CARRYING OUT THE INVENTION

The following describes embodiments of the present invention with reference to the drawings.

### Embodiment 1

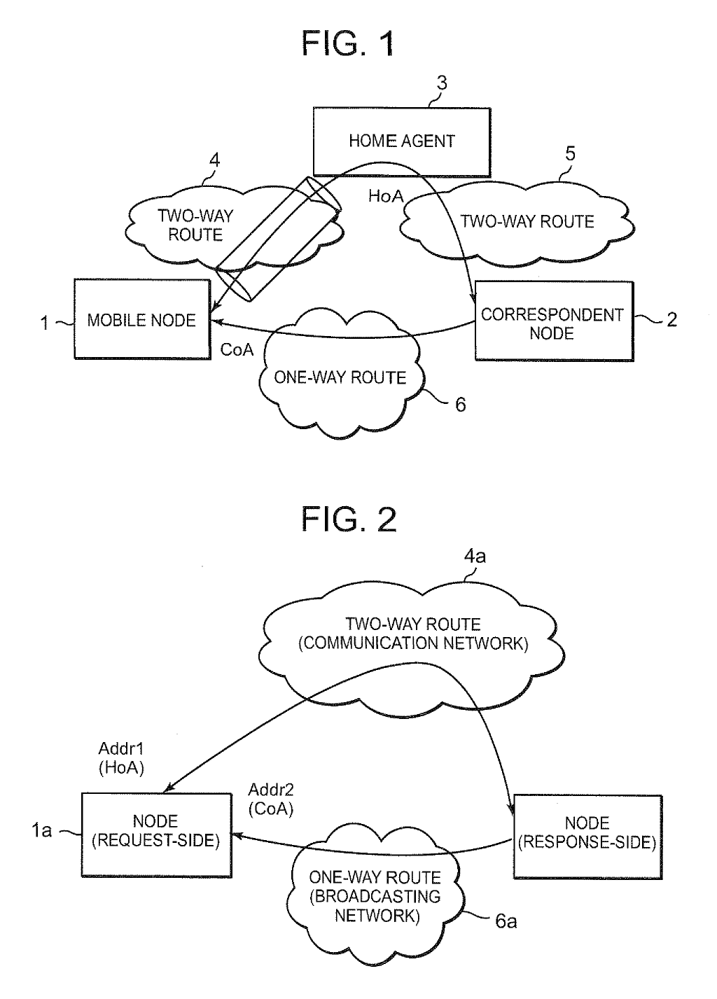

The present technique enables effective usage of a one-way route from a correspondent node (CN) to a mobile node (MN) in the case where the MN can make a communication with a home agent (HA) in two ways even when the MN moves, whereas the MN can make a communication with the CN only in one way from the CN to the MN. As illustrated in FIG. 1, routes 5 and 4 between a home agent 3 and a correspondent node 2 and between a mobile node 1 and the home agent 3 are communicable in two ways, but a route between the correspondent node 1 and the mobile node 2 is a route 6 communicable only in one way. Data can flow only in the direction from the correspondent node 2 to the mobile node 1. When a message is to be transmitted from the mobile node 1 to the correspondent node 2, the mobile node 1 has to transmit the message via the home agent 3.

In Mobile IP (Mobile IPv6) of the conventional technique, route optimization is possible only when communication can be made in two ways of a route between the MN 1 and the CN 2. That is, data communication is possible only via the HA 3, which is always a detour. According to the present technique, even when the route between the CN 3 and the MN 1 is such a one-way route 6, binding cache can be set so that the CN 3 can transmit data not to HoA but to CoA, thus transmitting a packet from the CN 3 to the MN 1.

Note that the following describes the case where the MN 1 is a mobile node and the HA 3 exists. However, as illustrated in FIG. 2 for example, a similar technique is applicable also to the case of a node 1a on an address generation information request-side having a multi-interface, including an interface connectable with a two-way communication route 4a (mobile phone network, WLAN, LAN or the like) and an interface receiving data from a one-way communication route 6a (broadcasting network or the like). In FIG. 2, the node 1a on the request-side has both of an address Addr1 communicable in two ways (corresponding to HoA of Mobile IP) and a reception-only address Addr2 (corresponding to CoA of Mobile IP).

Route optimization of Mobile IP enables the MN 1 to receive data in the one-way route 6 from the CN 2. In the route optimization of Mobile IP, the MN 1 sets binding cache in the CN 2. This binding cache describes that HoA and CoA are both addresses of the MN and the CN 2 transmits data to CoA not to HoA. The route optimization of Mobile IP is devised so as to prevent an attacker from setting this binding cache in an unauthorized manner. Such device, however, is available only for the two-way communicable route between the MN 1 and the CN 2. “The method to prevent unauthorized binding cache setting” adopted by Mobile IP will be described later with reference to FIG. 4.

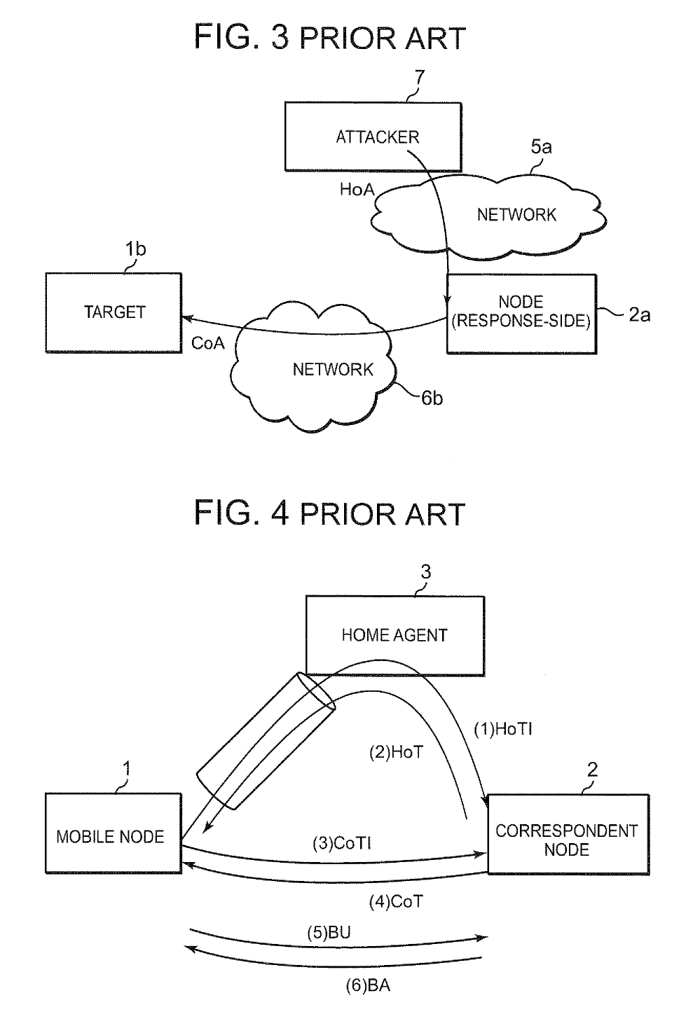

Referring firstly to FIG. 3, the following describes the case where binding cache is set in an unauthorized manner. Let that a node 2a on the address generation information response-side of FIG. 3 is a server that transmits a large amount of data such as a graphic data server. Let that an attacker 7 sets binding cache in an unauthorized manner so as to make the node 2a transmit a packet addressed to its own address (HoA) to an address (CoA) of a target 1b instead via a network 5a. When the attacker 7 requests the node 2a to transmit data, the node 2a sends a large amount of data to the target 1b (addressed to CoA) in accordance with the setting of the binding cache. In this way, the attacker 7 can exploit the response-side node 2a to conduct a denial of service (DoS attack) against the target 7.

As a method to prevent unauthorized setting of binding cache, Mobile IP adopts a method illustrated in FIG. 4. The Mobile IP (MIPv6) conducts a home address test procedure and a care-of address test procedure to confirm that HoA and CoA are correct addresses of the MN 1, respectively. In the home address test procedure,

(1) the mobile node (MN) 1 transmits a HoTI message to the correspondent node (CN) 2 with HoA being set as a source address, and

(2) the correspondent node 2 transmits a HoT message to HoA.

The home address test procedure tells that the mobile node 1 transmits a message with HoA being set as a source and receives a response message at HoA.

In the care-of address test procedure,

(3) the mobile node (MN) 1 transmits a CoTI message to the correspondent node (CN) 2 in a direct route with CoA being set as a source address, and

(4) the correspondent node 2 transmits a CoT message to CoA in a direct route.

The care-of address test procedure tells that the mobile node transmits a message with CoA being set as a source and receives a response message at CoA.

(5) The mobile node 1 includes results of the home address test procedure and the care-of address test procedure in a BU message and transmits the same to the correspondent node 2 in a direct route. The BU message is sent out with CoA being set as a source address.

(6) The correspondent node 2 confirms (authenticates) the results of the home address test procedure and the care-of address test procedure included in the BU message, and confirms that the mobile node 1 can communicate at both of HoA and CoA. After the authentication of the BU message, the correspondent node 2 sets binding cache of the mobile node 1 and transmits a BA message as a response in a direct route.

That is a procedure of the binding cache setting for route optimization in Mobile IP.

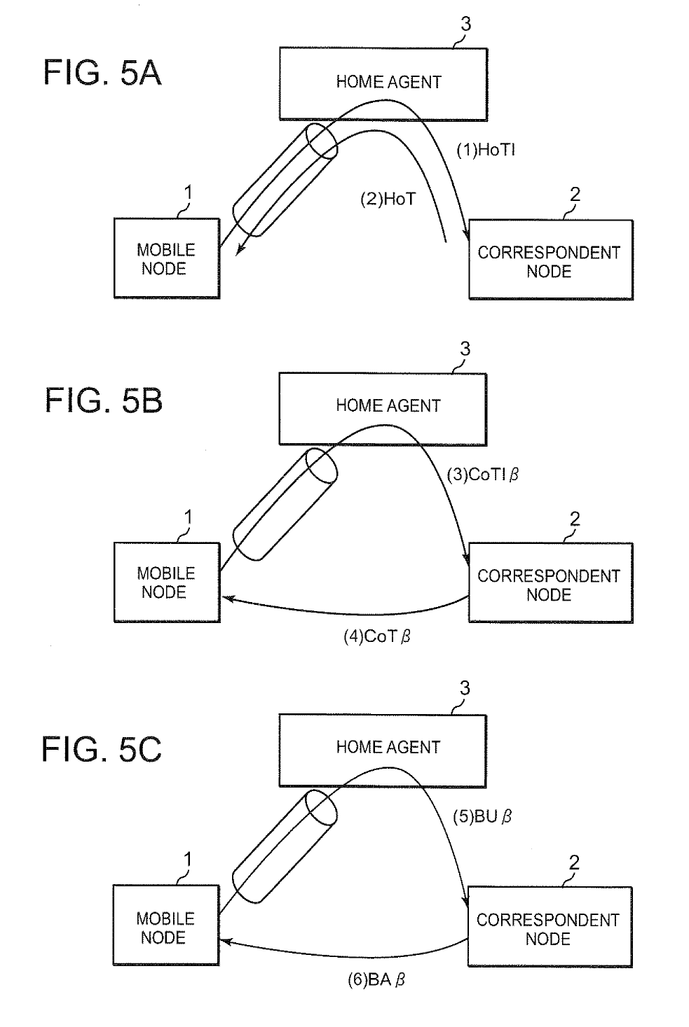

In the case where the direct route between the mobile node 1 and the correspondent node 2 is communicable only in one way, however, the binding update method in Mobile IP cannot be used. When communication can be made only from the correspondent node 2 to the mobile node 1 as the one way, the CoT message and the BA message can flow, but the CoTI message and the BU message cannot flow. Then, as illustrated in FIGS. 5B and 5C, a possible method is to transmit the CoTI message and the BU message via the home agent 3 with HoA being set as the source address. Hereinafter, the CoTI message and the BU message transmitted via the home agent 3 are called a CoTIβ message and a BUβ message, respectively. Response messages of these request messages are called a CoTβ message and a BAβ message, respectively.

In the home address test procedure illustrated in FIG. 5A, similarly to Mobile IP,

(1) a mobile node (MN) transmits a HoTI message to a correspondent node (CN) 2 with HoA being set as a source address, and

(2) the correspondent node 2 transmits a HoT message to HoA.

The home address test procedure tells that the mobile node 1 transmits a HoTI message with HoA being set as a source and receives a response message at HoA.

In the care-of address test procedure (β) illustrated in FIG. 5B,

(3) the mobile node 1 transmits a CoTIβ message to the correspondent node (CN) 2 via a home agent (HA) 3 with CoA being set as a source address, and

(4) the correspondent node 2 transmits a CoTβ message to CoA (direct route).

The care-of address test procedure tells that the mobile node 1 transmits a message with HoA being set as a source and receives a response message at CoA.

Next, as illustrated in FIG. 5C,

(5) The mobile node 1 conducts the home address test procedure and the care-of address test procedure (β) and, then includes results of the test in a BUβ message and transmits to the correspondent node 2 via the HA 3. (6) The correspondent node 2 checks the respective test results to confirm that the mobile node receives even when the transmission is made to CoA, thus setting binding cache. Then, the correspondent node 2 transmits, as a response, a BAβ message to the mobile node 1 in a direct route.

This method can prevent unauthorized binding cache being set for the correspondent node 2. Although the source address of the BUβ message is HoA, the destination address of the response message thereof (BAβ message) is CoA, which does not pose any problem because the care-of address test procedure (β) tells that the message can be transmitted to the mobile node 1 even when the transmission is made to CoA. The remaining last problem is the care-of address test procedure (β). When the mobile node 1 transmits a CoTIβ message, the CoTIβ message describes CoA as the destination address of the response. The correspondent node 2 receives the CoTIβ message and transmits the CoTβ message to CoA in accordance with the designation from the mobile node 1.

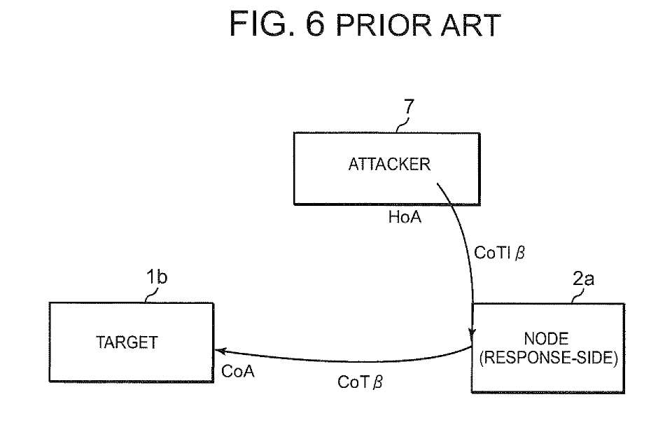

The state where an attacker exploits this care-of address test procedure (β) is described with reference to FIG. 6. The attacker 7 transmits a CoTIβ message to the node 2a while designating an address (CoA) of a target 1b as a response destination in the CoTIβ message. The node 2a transmits a CoTβ message to CoA in accordance with the designation of the CoTIβ message. The node 2a does not know CoA as the response destination address until it receives the CoTIβ message, and therefore the node 2a cannot tell whether the target 7 exists at CoA or an authenticate mobile node 1 is waiting for a response message. The node 2a may be notified of CoA beforehand, but the attacker 7 can notify the same beforehand, and therefore this cannot be a preventive means. The node 2 cannot tell the reachability to the mobile node 1 until a trial transmission is made to CoA. The attacker 7 may exploit this “trial transmission by the node 2” for an attack. Especially as for such a denial of service (DoS attack), a server whose address is open to public to provide a service is susceptible to be a target of the attack.

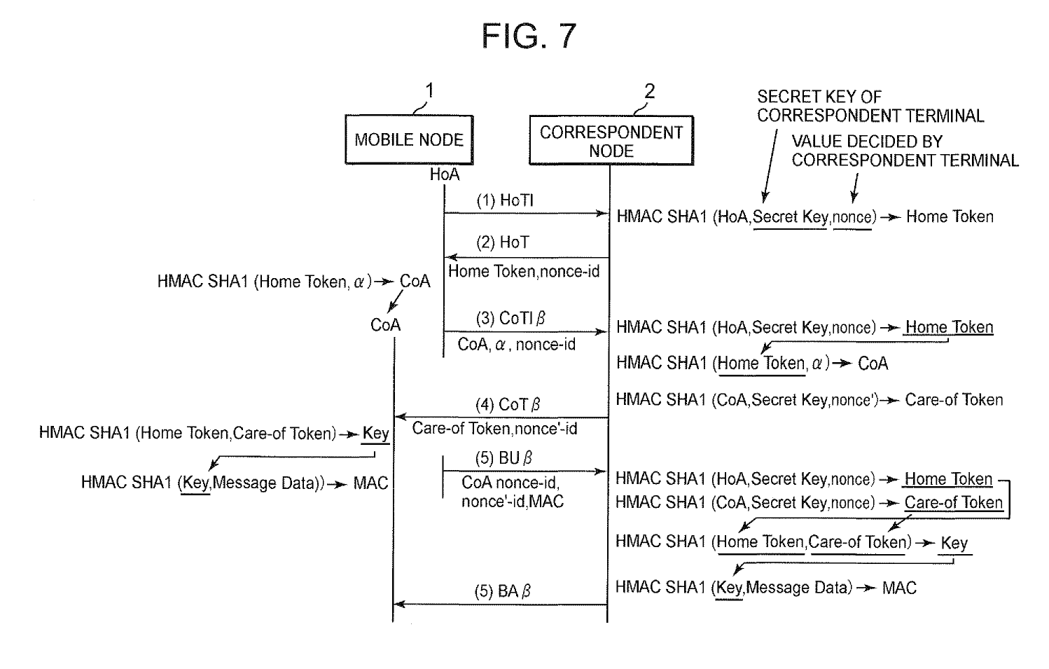

The present technique copes with the above-stated problems. An outline will be given referring to FIG. 7. The mobile node 1 conducts a home address test procedure of Mobile IP. More specifically,

(1) the mobile node 1 transmits a HoTI message to the correspondent node 2, and

(2) the correspondent node conducts a usual home address test procedure of Mobile IP. That is, using HoA as a source address of the HoTI message, a secret key of the correspondent node 2, and a nonce determined by the correspondent node 2, the correspondent node 2 conducts a Hash calculation by HMAC_SHA1 to find a Home Keygen Token (hereinafter called Home Token) as follows,

Home Token=SHA1(HoA,Secret Key,nonce).

The correspondent node 2 includes the calculated value of Home Token and identification information nonce-id to call nonce and transmits the same. The procedure so far is the same as in the normal Mobile IP. However, the present technique is different in that Home Token is used as CoA generation information of the mobile node 1.

<CoA Generation>

Next, the mobile node 1 uses information included in the received HoT message to set CoA. In the conventional method, the mobile node 1 decides CoA prior to transmission of a HoTI message. A feature of the present technique resides in that the mobile node 1 receives a HoT message, and then generates CoA based on Home Token included in the HoT message. Since a region of a network prefix of the generated CoA cannot be changed, the mobile node 1 generates a region of host identification information other than that region using Home Token. If the same address as the generated CoA has been already used, the mobile node 1 cannot use the address, and therefore the mobile node 1 generates CoA using data a that gives a degree of freedom to avert a collision of address when duplication of the address occurs. That is, the mobile node 1 uses Home Token included in the HoT message and a to give a degree of freedom to conduct a Hash calculation using HMAC_SNA1, thus generating CoA as follows,

CoA=SHA1(Home Token,α).

Next, the mobile node 1 conducts a care-of address test procedure (β). More specifically,

(3) the mobile node 1 includes the generated CoA and the information α used for the generation of CoA in a CoTIβ message, and transmits the same to the correspondent node 2. This CoTIβ message also includes (2) nonce-id transmitted with the HoT message.

<CoA Confirmation>

Receiving the CoTIβ message, the correspondent node 2 firstly conducts calculation of Home Token as follows. Since the source address of the CoTIβ message is HoA, HoA and nonce from nonce-id included in the CpTIβ are called. A secret key of the correspondent node 2 also is used,

Home Token=SHA1(HoA,Secret Key,nonce).

Further, using the generated Home Token and the information α included in the CoTIβ message, CoA is generated,

CoA=SHA1(Home Token,α).

If the generated CoA is equal to CoA included in the CoTIβ message, the correspondent node 2 judges that a response message can be transmitted to CoA.

When the correspondent node 2 transmits a CoTβ message in response to the CoTIβ message, the correspondent node 2 conducts a calculation of a Care-of keygen token (hereinafter called Care-of Token). The calculation of Care-of Token uses CoA, the secret key of the correspondent node 2, and a nonce decided by the correspondent node 2 to conduct a Hash calculation using HMAC_SHA1,

Care-of Token=SHA1(CoA,Secret Key,nonce′).

(4) The correspondent node includes a value of the calculated Care-of Token and identification information nonce′-id to call nonce′ in the CoTβ message as a response message, and transmits the same.

The mobile node 1 acquires Home Token by the home address test procedure. Further, the mobile node 1 acquires Care-of Token by the care-of address test procedure (β). The mobile node 1 generates key data based on these Tokens,

Key=SHA1(Home Token,Care-of Token).

Then, using this key data, the mobile node 1 generates a message authentication code (MAC) of a BUβ message transmitted,

MAC=SHA1(Key,message Data).

(5) The mobile node 1 includes CoA as a destination of a response message, nonce-id as information to generate Token, nonce′-id, and the message authentication code (MAC) in the BUβ message and transmits the same to the correspondent node 2.

Receiving the BUβ message, the correspondent node 2 conducts a confirmation procedure as to whether the message is correct or not. Firstly, Home Token and Care-of Token are calculated. The source address of the BUβ message is HoA, which is used for calculation of the Home Token. CoA is included in the BUβ message as a response destination address, which is used for a calculation of the Care-of Token,

Home Token=SHA1(HoA,Secret Key,nonce),

Care-of Token=SHA1(CoA,Secret Key,nonce′).

Next, key data (Key) is generated based on these Tokens, a message authentication code (MAC) is generated from message data of a BUβ message and Key, and confirmation is made whether the generated message authentication code agrees with the message authentication code included in the BUβ message,

Key=SHA1(Home Token,Care-of Token),

MAC=SHA1(Key,Message Data).

(6) If the message authentication code included in the BUβ message agrees with a value calculated by the correspondent node 2, the correspondent node 2 judges it as a correct BUβ message, sets binding cache as the combination of HoA and CoA, and transmits a BAβ message as a response message of the BUβ message to the mobile node 1.

That is a description for the flow of the home address test procedure, the care-of address test procedure (β), one-way route/route optimization procedure.

The above-stated generation method of a response destination address (CoA) can prevent the attacker 7 from doing a denial of service attack using the care-of address test procedure (CoTIβ/CoTβ). That is, even when the attacker 7 tries to attack a server and designates an address of the server as a response destination address, a response-side node 2a confirms whether the response destination address can be generated from the Home Token or not, thus stopping the attack before transmitting a response message.

Further, the attacker 7 cannot expect the Home Toke returned from the response-side node 2a, and therefore the attacker 7 cannot generate an address of a server as a target intentionally. Since the Home Token is generated based on the secret key of the response-side node 2a and is generated using a nonce generated by the response-side node 2a, the request-side node cannot expect the Home Token. Further, the nonce has a life time, which is changed into a different value regularly, and therefore it is impossible for the request-side node to operate intentionally so that an address of a server as a target becomes a response destination address.

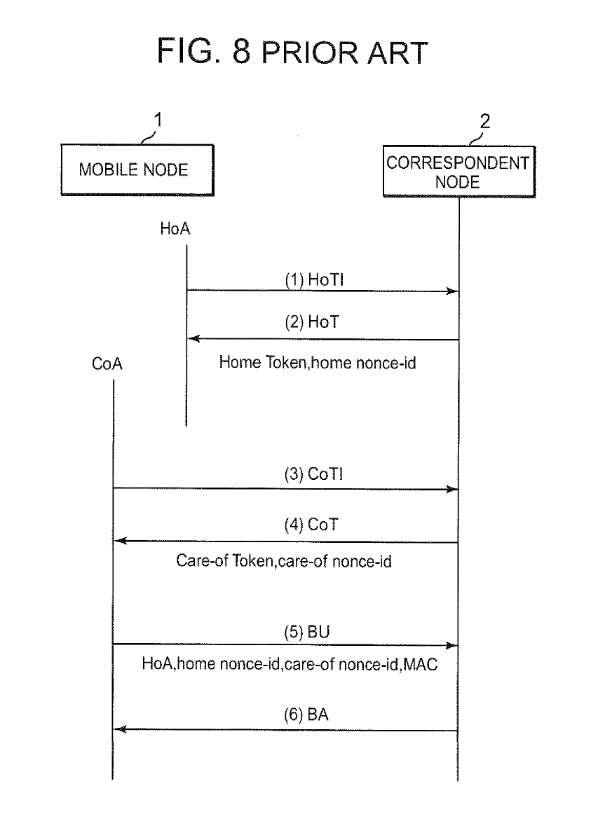

The following describes the technique in further details. Firstly, a method of Mobile IP as the conventional technique is briefly described below for comparison purposes, with reference to FIG. 8.

<HoTI/CoTI>

Firstly, as illustrated in FIGS. 8(1) and (3), the node 1 transmits, to the correspondent node 2, a HoTI (Home test Init) message and a CoTI (Care-of Test Init).

<HoT/CoT>

Receiving the HoTI message, the correspondent node 2 calculates Home Token as follows,

Home Token:=First(64,HMAC_SHA1(Kcn,(home address|nonce|0))).

Kcn is key data that the correspondent node 2 only knows. The Home address is a source address of the HoTI message. Nonce is a value that the correspondent node 2 can decide at its own discretion. As can be understood what value is used as Nonce, as illustrated in FIG. 8(2), the correspondent node 2 notifies the mobile node 1 of identification information (home nonce-id) to identify the value of nonce, which is included in a HoT message. The HoT message further includes Home Token.

Similarly, receiving the CoTI message, the correspondent node 2 calculates Care-of Token as follows,

Care-of Token:=First(64,HMAC_SHA1 (Kcn,(care-of address|nonce|1))).

As illustrated in FIG. 8(4), the correspondent node 2 includes the Care-of Token and the care-of nonce-id in the CoT message and transmits the same to the mobile node 1.

<BU>

Receiving the HoT message and the CoT message, the mobile node 1 uses the Home Token and the Care-of Token to generate a key (Kbm) as follows,

Kbm=SHA1(Home Token|Care-of Token).

The mobile node 1 uses the thus generated Kbm to generate a message authentication code (MAC) of a BU message and adds the same to the BU message, and as illustrated in FIG. 8(5) transmits the same to the correspondent node 2. The message authentication code is generated as follows,

Authenticator=First(96,HMAC_SHA1(Kbm,Mobility Data)),

Mobility Data=care-of address|correspondent|MH Data.

Authenticator is the message authentication code. Care-of address is a source address of the BU message, and correspondent is an address of the correspondent node 2 and is a destination address of the BU message. MH Data is a body of the BU message.

<Authentication of BU/BA>

The mobile node 1 adds home nonce id, care-of nonce id, and home address to the BU message, and transmits the same. Receiving the BU message, the correspondent node 2 calls a source address (care-of address) of the BU message and home nonce from the home nonce id to generate Home Token. The correspondent node 2 further generates Care-of Token in a similar manner. The correspondent node 2 further generates a key (Kbm) from these two tokens. Then, the correspondent node 2 uses the BU message and the key (Kbm) to generate a message authentication code, and confirms whether the thus generated code agrees with the message authentication code added by the mobile node 1 to the BU message. If the message authentication code agrees, the correspondent node 2 considers it as an appropriate message from the node executing both of the Home Test (HoTI message is transmitted and HoT message is received) and the Care-of Test (CoTI message is transmitted and CoT message is received), and transmits a binding confirmation (BA) message to the mobile node 1 as illustrated in FIG. 8(6).

The design concept of the home address test procedure and the care-of address test procedure of Mobile IP in this conventional technique is described in Non-Patent Document 2. Features are the following three points:

(1) to prevent a correspondent node from having a state;

(2) to prevent amplification of a response message (To prevent Amplification); and

(3) to prevent reflection of a message (To prevent Reflection.)

To prevent a correspondent node 2 from having a state in the above-stated (1) is a preventive measure for a DoS attack against the correspondent node 2. During the procedure of receiving a HoTI message and returning a HoT message as a response, the correspondent node 2 simply calculates a token. After returning the HoT message, there is no information that the correspondent node 2 has to store. Since the same values as a value of Kcn and a value of nonce can be used for a plurality of HoTI messages, even when the correspondent node 2 receives HoTI messages from a plurality of mobile nodes 1 at the same time, this does not mean an increase in the information to be kept. The same goes for the reception of a CoTI message and the transmission of a CoT message. Receiving a BU message, the correspondent node 2 generates Home Token and Care-of Token using only information included in the BU message, generates a key (Kbm) from these two tokens, generates a message authentication code of the BU message, and further confirms whether the thus generated code aggress with the message authentication code added to the BU message.

To prevent amplification of a response message in the above-stated (2) (To prevent Amplification) is implemented by a division into the Home test and the Care-of Test. For instance, a method can be considered where the mobile node 1 transmits one request message to the correspondent node 2 so as to make the correspondent node 2 transmit different response messages to HoA and CoA. In this method, however, there is a possibility of giving an attacker 7 who attempts a DoS attack a device doubling an attack message. Therefore, Mobile IP is designed so that one response message is to be returned in response to one request message.

To prevent reflection of a message in the above-stated (3) (To prevent Reflection) is implemented by transmitting a response message to a source address of a request message. That is, the HoT message is returned to the source of the HoTI message, and the CoT message is returned to the source of the CoTI message. To transmit a response message to an address other than the source of the request message allows the attacker 7 to exploit the correspondent node 2 for an attack against other nodes.

The present embodiment is a technique enabling route optimization in one-way route that would not be implemented by Mobile IP as the conventional technique, while having an object of maintaining the above-stated three points of security measures. Among them, two points of preventing a correspondent node 2 from having a state and preventing amplification are maintained. Further, it is devised so that reflection cannot be exploited as an attack.

<Message Sequence>

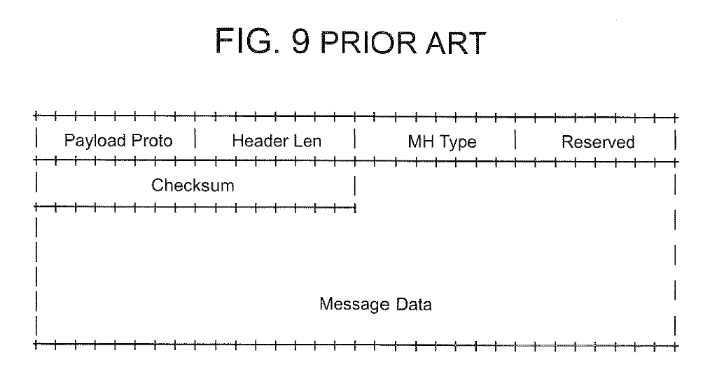

Next, a message sequence of binding cache setting of the present embodiment will be described below. In order to distinguish it from the conventional Mobile IP, a CoTIβ message, a CoTβ message, a BUβ message, and a BAβ message are newly defined. It is desirable that these messages can be easily distinguished from messages of the conventional Mobile IP. In the conventional Mobile IP, a CoTI message, a CoT message, a BU message, and a BA message are identified using MH type in a format illustrated in FIG. 9. The MH type is an 8-bit information element, to which values from 0 to 7 are assigned as follows (see Non-Patent Document 1),

0 Binding Refresh Request

1 Home Test Init

2 Care-of Test Init

3 Home Test

4 Care-of Test

5 Binding Update

6 Binding Acknowledgement

7 Binding Error.

Therefore, it can be considered that a method enabling the respective message to be identified is suitable also for messages newly defined for the present technique by assigning a MH type value newly thereto. Instead of defining a new MH type value, it is also possible to identify the messages using information elements in a destination address, a source address, or a message using a CoTI message (MH type=2) for a CoTIβ message, a CoT message (MH type=4) for a CoTβ message, a BU message (MH type=5) for a BUD message, and a BA message (MH type=6) for a BAβ message. It is further possible to provide a flag for identification to a head of a message.

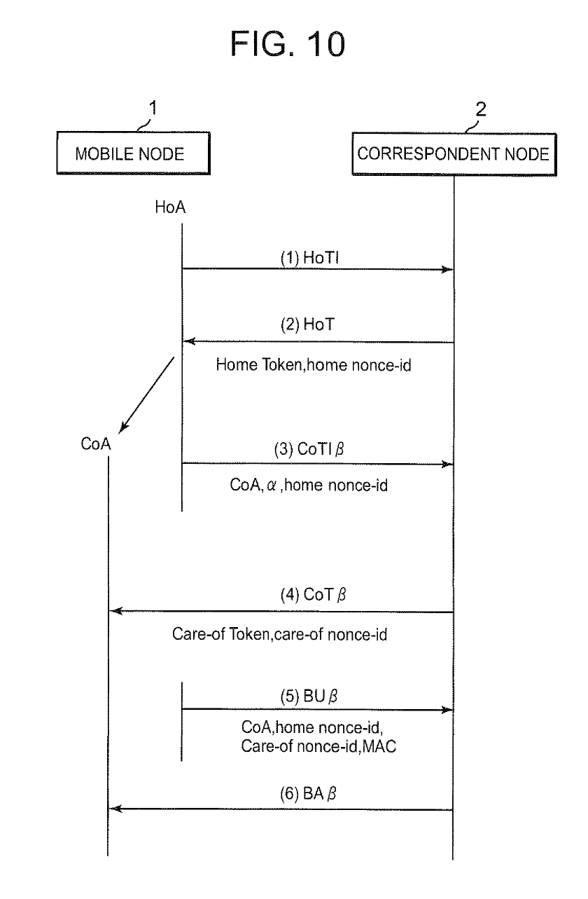

Next, a flow of the procedure of the present invention will be described below, with reference to FIG. 10.

<HoTI, HoT>

As illustrated in FIG. 10(1), the mobile node 1 transmits a HoTI message to the correspondent node 2.

Receiving the HoTI message, the correspondent node 2 calculates Home Token as follows,

Home Token:=First(64,HMAC_SHA1(Kcn,(home address|nonce|0))).

As illustrated in FIG. 10(2), the correspondent node 2 includes Home Token and home nonce-id in a HoT message and transmits the same to the mobile node 1. The home address test procedure using the HoTI and the HoT message is similar to the procedure in Mobile IP. However, the present invention is different in that the following CoA generation procedure uses Home Token.

<CoA Generation Procedure>

Receiving the HoT message, the mobile node 1 calculates a care-of address (CoA) as a response destination address as follows,

Care-of Address:=First(64,HMAC_SHA1(Home Token|α)).

The above equation is in the case where the size of a network prefix is 64 bits. Since the address size of IPv6 is 128 bits, a host identification region is 64 bits in length. The above-stated Care-of Address is data in the host identification region.

After generating CoA, the mobile node 1 conducts an address duplication confirmation procedure as to whether any terminal using the same address already exists on a network or not. In this address duplication confirmation procedure, a message is transmitted to the thus generated address. If the address has been already used by another terminal, a response will be returned therefrom. In this way, this procedure confirms whether the address has been already used by another terminal or not. If the generated CoA has been already used by another terminal, the mobile node 1 changes the value of a to generate a CoA again, and conducts the address duplication confirmation procedure. This procedure is conducted until a CoA that has not been used by another terminal can be generated.

<CoTIβ>

As illustrated in FIG. 10(3), a CoTIβ message newly includes CoA, α, and home nonce-id, unlike the CoT message. CoA is a response destination address generated from Home Token by the CoA generation procedure. α is a value used to generate CoA. Home nonce-id is a value included in the HoT message that the mobile node receives.

<Reception of CoTIβ and Confirmation of Response Destination Address CoA>

The correspondent node 2 that receives the CoTIβ message calls home nonce from the home nonce-id included in the CoTIβ message, and generates Home Token in combination with HoA as the source address of the CoTIβ message,

Home Token:=First(64,HMAC_SHA1(Kcn,(home address|nonce|0))).

Further, the correspondent node 2 uses Home Token and a included in the CoTIβ message to generate a response destination address (care-of address),

Care-of Address:=First(64,HMAC_SHA1(Home Token|α)).

If the thus generated Care-of Address does not agree with the response destination address included in the CoTIβ message, the correspondent node 2 finishes the procedure and discards the CoTIβ message. If the generated address agrees with the response destination address, a CoTIβ message as a response message is generated. This confirmation procedure of the response destination address confirms that the terminal that transmits the CoTIβ message conducts a home address test procedure and generates the response destination address using Home Token transmitted from the correspondent node 2. This can prevent an attacker 7 from exploiting the correspondent node 2 to transmit a CoTβ message to a target 1b.

<CoTβ>

As illustrated in FIG. 10(4), the correspondent node 2 transmits the CoTβmessage to CoA of the mobile node 1. The CoTβ message includes Care-of Token and care-of nonce-id that calls nonce used for token generation. Care-of Token is calculated as follows,

Care-of Token:=First(64,HMAC_SHA1(Kcn,(care-of address|nonce|1))).

<BUβ>

Receiving the CoTβ message, the mobile node 1 generates key data (Kbm) based on the value of Care-of Token included in the CoTβ message and the value of Home Token included in the HoT message,

Kbm=SHA1(Home Token|Care-of Token).

Further, using this key data Kbm, the mobile node 1 generates a message authentication code of a BUβ message, adds the same to the BUβ message as illustrated in FIG. 10(5), and transmits the same to the correspondent node 2. The message authentication code is calculated as follows,

Authenticator=First(96,HMAC_SHA1(Kbm,Mobility Data)),

Mobility Data=care-of address|correspondent|MH Data.

Authenticator is the message authentication code. Home address is a source address of the BUβ message, and correspondent is a destination address. MH Data is a body of the BUβ message. In addition to the message authentication code, the BUβ message includes CoA as a response destination address, home nonce id included in the HoT message, care-of nonce id included in the CoTβ message.

<Authentication of BUβ and transmission of BAβ>

Receiving the BUβ message, the correspondent node 2 generates Home Token from home nonce-id and home address as the source address and generates Care-of Token from care-of nonce-id and care-of address included in the BUβ message,

Home Token:=First(64,HMAC_SHA1(Kcn,(home address|nonce|0))),

Care-of Token:=First(64,HMAC_SHA1(Kcn,(care-of address|nonce|1))).

Next, the correspondent node 2 generates Kbm using the two tokens, generates a message authentication code of the BUβ message, and confirms whether the message authentication code agrees with the message authentication code added,

Kbm=SHA1(Home Token|Care-of Token),

Authenticator=First(96,HMAC_SHA1(Kbm,Mobility Data)), and

Mobility Data=care-of address|correspondent|MH Data.

If there is agreement for the message authentication code, the correspondent node 2 sets binding cache, and transmits a BAβ message as a response message to CoA of the mobile node 1. If there is no agreement, the correspondent node 2 discards the received BUβ message and finishes the reception procedure. That is the binding update procedure to conduct route optimization in one-way route of the present invention.

<Message Format>

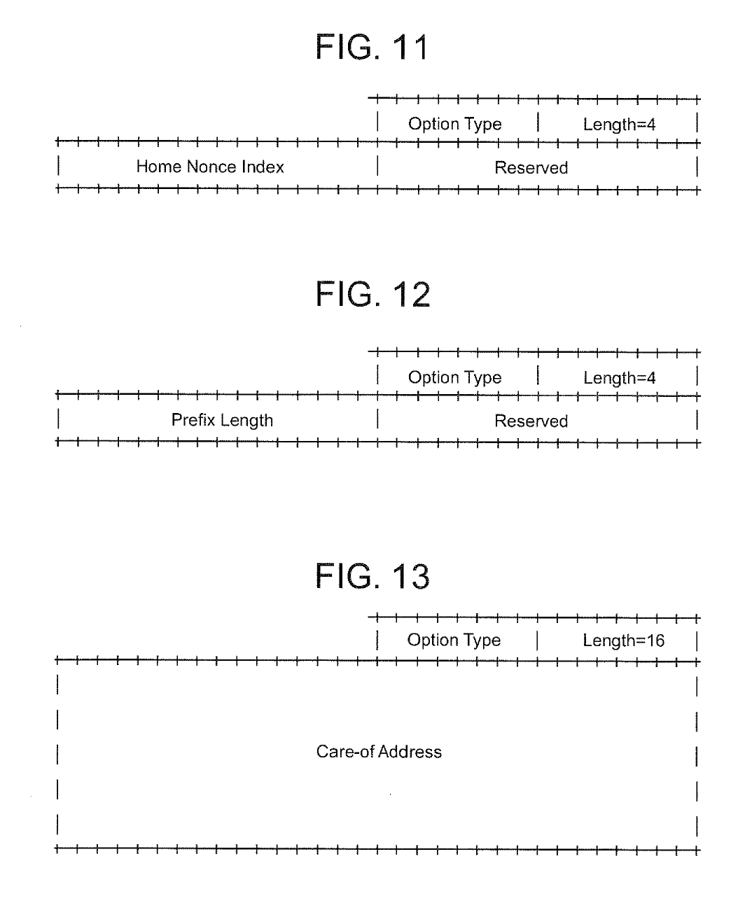

Next, a message format will be described below. CoTIβ and CoTβ messages of the present invention include new information elements added to CoTI and CoT messages of the conventional technique Mobile IP. The information elements added are home nonce id, prefix length, and care-of address. As a format storing them, a message format defined in the conventional Mobile IP (RFC3775) itself or a slightly modified thereof can be used.
Home nonce id: since RFC3775 does not define Mobility Option conveying Home Nonce Index only, Option Type has to be newly defined as illustrated in FIG. 11.
Prefix length is information required to, when the correspondent node 2 makes a comparison of Care-of Address, separate Care-of Address from a region of a network prefix and a region of host identification information. FIG. 12 illustrates an information element conveying the size of the network prefix.
Care-of address: since Care-of Address Option does not exist in RFC3775, Option Type has to be newly defined as illustrated in FIG. 13. Alternate CoA Option may be used for this purpose.

<Binding Cache>

Binding cache set by the correspondent node 2 may be the same as in Mobile IP. Similarly to the conventional Mobile IP, the correspondent node 2 changes a destination of a packet addressed to HoA into CoA, and adds a routing header (Type 2) of an extension header. A packet that the correspondent node 2 receives from the mobile node 1 is a normal packet with HoA being set as a source address. On the other hand, the binding cache that the mobile node 1 has requires information indicating that the source address should not be changed to CoA. This is because a packet does not reach the correspondent node 2 unless the mobile node 1 transmits the packet via a home agent 3.

<Configuration of Correspondent Node (Response-Side Node)>

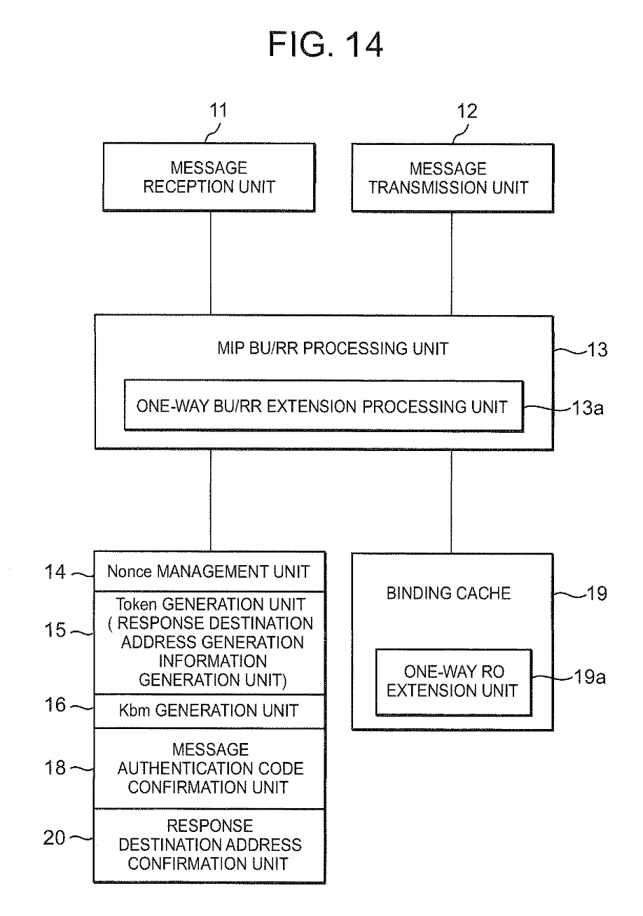

FIG. 14 is a block diagram illustrating a message processing unit of the correspondent node (response-side node) 2. The correspondent node 2 transmits and receives messages as follows,

(1) to receive a HoTI message and transmit a HoT message including CoA generation information (Home Token),

(2) to receive a CoTI message and transmit a CoT message,

(3) to receive a CoTIβ message to authenticate CoA in the message and transmit a CoTβ message,

(4) to receive a BU message to authenticate a message authentication code in the message and transmit a BA message, and

(5) to receive a BM message to authenticate a message authentication code in the message and transmit a BAβ message.

A MIP BU/RR processing unit 13 (and a message reception unit 11 and a message transmission unit 12) conducts the message transmission/reception procedures of (1), (2) and (4). A one-way BU/RR extension processing unit 13a (and the message reception unit 11 and the message transmission unit 12) conducts the message transmission/reception procedures of (3) and (5). In the case where token and nonce-id are added to the messages in the transmission procedures of HoT, CoT, and CoTβ messages, data is acquired from a Nonce management unit 14 and a Token generation unit 15. The Token generation unit 15 acquires a value of Nonce from the Nonce management unit 14, and calculates a value of Token based on an address acquired from the received request message and key data Kcn. The Nonce management unit 14 passes, to the MIP BU/RR processing unit 13, a value of Nonce ID corresponding to the value of Nonce passed to the Token management unit 14. The Token generation unit 15 generates Home token in response to a request for response destination address generation information from the request-side node 1, thus functioning as a response destination address generation information generation unit.

In the case where a confirmation procedure of a response destination address is conducted in the CoTIβ message reception procedure, home nonce-id included in the CoTIβ message is passed to the Nonce management unit 14, and a value of Nonce is acquired. The acquired value of Nonce and HoA as the source address of the CoTIβ message are passed to the Token generation unit 15, and a value of Token is acquired. The value of the acquired Token and information a included in the CoTIβ message are passed to a response destination address confirmation unit 20, a response destination address (CoA) is generated, and comparison is made whether the thus generated address agrees with the response destination address included in the CoTIβ message. The compared region is a region of a host identifier obtained by removing a network prefix region from the response destination address.

In the case where a message authentication code is generated and confirmed (authenticated) in the BU and BUβ messages reception procedure, home nonce-id and care-of nonce-id included in the BU and BUβ messages are passed to the Nonce management unit 14, and values of the home nonce and the care-of nonce are acquired. The acquired values of Nonce, Home address and Care-of Address included in the BU and BUβ messages are passed to the Token generation unit 15, and Home Token and Care-of Token are generated. The thus acquired two tokens are passed to a Kbm generation unit 16, thus generating Kbm. The thus generated Kbm and the received message are passed to a message authentication code (MAC) confirmation unit 18 to calculate a value of MAC. Then, the calculated value is compared with a value of the MAC included in the BU and BUβ messages, thus checking whether they agree or not. If the checking of MAC succeeds, a correspondence between Home Address and Care-of Address is registered in a binding cache 19 (and a one-way RO extension unit 19a).

<Configuration of Mobile Node (Request-Side Node)>

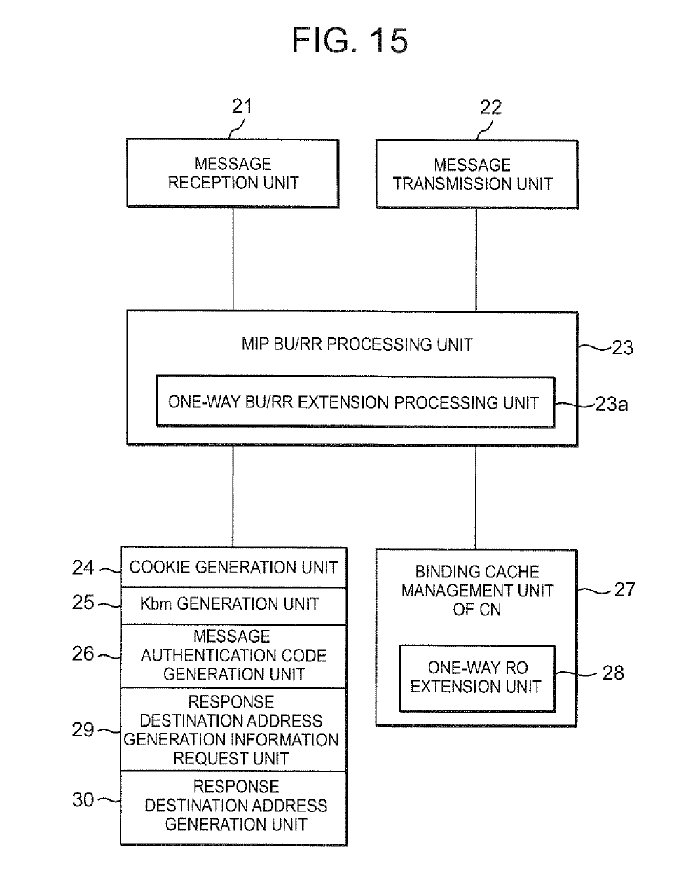

FIG. 15 is a block diagram illustrating the configuration of a message processing unit of the mobile node (request-side node) 1. The mobile node 1 transmits and receives messages as follows,

(1) to transmit a HoTI message and receive a HoT message including CoA generation information (Home Token),

(2) to transmit a CoTI message and receive a CoT message,

(3) to generate a CoA from CoA generation information (Home Token), transmit a CoTIβ message including CoA and receive a CoTβ message,

(4) to transmit a BU message including a message authentication code and receive a BA message, and

(5) to transmit a BUβ message including a message authentication code and receive a BAβ message.

A MIP BU/RR processing unit 23 (and a message reception unit 21 and a message transmission unit 22) conducts the message transmission/reception procedures of (1), (2) and (4). A one-way BU/RR extension processing unit 23a conducts the message transmission/reception procedures of (3) and (5). In the transmission procedures of HoTI, CoTI, and CoTIβ messages, a value of Cookie generated by a Cookie generation unit 24 is inserted in the HoTI, CoTI, and CoTIβ messages. As for the Cookie included in the messages, the correspondent node 2 is supposed to include the same value in a response message and return the same to the mobile node 1. Thereby, the mobile node 1 can associate the request message with the response message. A response destination address generation information request unit 29 makes a request by HoTI message transmission in (1), and a response destination address generation unit 30 generates CoA from CoA generation information (Home Token) in (3).

In the HoTI message transmission procedure, a procure to request Home Token corresponds to the procedure to request response destination address generation information (Home Token) from the response-side node 2, thus considering that the response destination address generation information request unit 29 exists. In the HoT message reception procedure, the mobile node 1 passes Home Token included in the HoT message to the response destination address generation unit 30, thus generating a response destination address (CoA). In the CoTIβ message transmission procedure, a response destination address generated by the response destination address generation unit 30 and information a used for the response destination address generation are acquired, which are added to the CoTIβ message for transmission.

In the BU and BUD message transmission procedure, Home Token and Care-of Token acquired from the received HoT message and CoTβ message are passed to a Kbm generation unit 25, thus generating Kbm. Further, the BU and BUβ messages to be transmitted and the generated Kbm are passed to a message authentication code generation unit 26, thus creating a message authentication code. The created message authentication code is added to the BU and BUβ messages for transmission. A Binding Cache management unit 27 (and a one-way RO extension unit 28) manages the Binding Cache 19 of the correspondent node 2.

### Other Usage Example 1

The present specification describes so far the case where the mobile node 1 operates from the beginning on the assumption that one-way route optimization would be conducted. The present invention is further applicable to the case where the mobile node 1 does not know whether one-way route is included or not. The mobile node 1 conducts a conventional Mobile IP procedure to transmit a HoTI message and a CoTI message. If the mobile node 1 receives a HoT message but cannot receive a CoT message, a possible procedure is to transmit a CoTI message again. At this time, the mobile node 1 makes a judgment as to whether route optimization is to be conducted even for one-way route (in the case of a route that is communicable only in one way from the correspondent node 2 to the mobile node 1), and if the one-way route optimization is to be conducted, the mobile node 1 transmits a CoTIβ message. The procedure following this is the same as in the procedure described in the present specification.

### Other Usage Example 2

When the mobile node (MN) 1 has a plurality of interfaces as illustrated in FIG. 2, one-way route optimization can be executed even when the home agent 3 does not exist. Assuming that the mobile node 1 has two types of interfaces, which, for example, may be an interface connecting with a mobile phone network and an interface receiving digital terrestrial television broadcasting, an address assigned to the interface on the mobile phone network side is an IP (mobile) that is an address communicable in two ways, and the interface on the digital terrestrial television broadcasting side is an IP (broadcasting) that is an address communicable only in downlink, a mobile phone as the mobile node 1 can execute a one-way route optimization procedure considering that the IP (mobile) is HoA and the IP (broadcasting) is CoA.

The present specification describes a method of confirming whether a response destination address is correctly generated or not in order to check whether a response message is to be transmitted in response to a CoTIβ message. This method, however, is applicable to the case where the response-side node (correspondent node) 2 does not know the combination of HoA and CoA as well. For instance, in the case where binding cache of the mobile node 1 has been already set in the correspondent node 2, the correspondent node 2 knows that a packet can reach the mobile node 1 even transmission is made to CoA. In such a case, another possible method is that the correspondent node 2 does not confirm a response destination address, but confirms whether the binding cache of the mobile node 1 has been already set or not and confirms whether it agrees with the registered combination of HoA and CoA. In this way, in the case where the method of confirming whether the binding cache has been set or not is used together, a flag may be provided to a CoTIβ message so as to allow the correspondent node 2 to start checking the binding cache immediately whether the registration has been already made in the binding cache or not.

Since Mobile IP provides Life Time in the binding cache, the mobile node 1 has to transmit a CoTIβ message to the correspondent node 2 at regular intervals. Therefore, to use the method of confirming whether registration is made in the binding cache or not together with the method of confirming whether the response destination address is correctly generated or not is effective as a method to judge whether the CoTβ message can be transmitted as a response to CoA or not when receiving the CoTIβ message.

The present invention is further applicable to the case where route optimization is conducted for communication in a two-way direct route without a home agent of a mobile node intervening between the mobile node and a correspondent node. A communication method, a communication system, a mobile node and a correspondent node in this case will be described below.

(1) Communication Method:

A communication method of conducting route optimization for communication in a direct route between a mobile node and a correspondent node without a home agent of the mobile node intervening therebetween, includes the steps of:

a home address test step where the mobile node transmits a home address test request (HoTI) message to the correspondent node via the home agent, and the correspondent node transmits, in response to the home address test request message, a home address test response (HoT) message including address generation information to generate a care-of address of the mobile node to the mobile node via the home agent; and

a care-of address test step where the mobile node generates a care-of address based on the address generation information in the home address test response message, transmits a care-of address test request (CoTIβ) message including the care-of address to the correspondent node via the direct route, and when the correspondent node compares the care-of address in the care-of address test request message with the care-of address generated based on the address generation information transmitted with the home address test response (CoTβ) message and confirms agreement thereof, the correspondent node transmits a care-of address test response message to the mobile node via the direct route.

(2) Communication System:

A communication system that conducts route optimization for communication in a direct route between a mobile node and a correspondent node without a home agent of the mobile node intervening therebetween, includes:

home address test means adapted so that the mobile node transmits a home address test request message to the correspondent node via the home agent, and the correspondent node transmits, in response to the home address test request message, a home address test response message including address generation information to generate a care-of address of the mobile node to the mobile node via the home agent; and

care-of address test means adapted so that the mobile node generates a care-of address based on the address generation information in the home address test response message, transmits a care-of address test request message including the care-of address to the correspondent node via the direct route, and when the correspondent node compares the care-of address in the care-of address test request message with the care-of address generated based on the address generation information transmitted with the home address test response message and confirms agreement thereof, the correspondent node transmits a care-of address test response message to the mobile node via the direct route.

(3) Mobile Node:

A mobile node in a communication system that conducts route optimization for communication in a direct route between the mobile node and a correspondent node without a home agent of the mobile node intervening therebetween, comprising:

means that transmits a home address test request message to the correspondent node via the home agent;

means that, when the correspondent node transmits, in response to the home address test request message, a home address test response message including address generation information to generate a care-of address of the mobile node to the mobile node via the home agent, receives the home address test response message; and

means that generates a care-of address based on the address generation information in the received home address test response message, and transmits a care-of address test request message including the care-of address to the correspondent node via the direct route,

wherein when the correspondent node compares the care-of address in the care-of address test request message with the care-of address generated based on the address generation information transmitted with the home address test response message and confirms agreement thereof, the correspondent node transmits a care-of address test response message to the mobile node via the direct route.

(4) Correspondent Node:

A correspondent node in a communication system that conducts route optimization for communication in a direct route between a mobile node and the correspondent node without a home agent of the mobile node intervening therebetween, comprising:

means that, when the mobile node transmits a home address test request message to the correspondent node via the home agent, receives the home address test request message;

means that, in response to the received home address test request message, transmits a home address test response message including address generation information to generate a care-of address of the mobile node to the mobile node via the home agent;

means that, when the mobile node generates a care-of address based on the address generation information in the home address test response message and transmits a care-of address test request message including the care-of address to the correspondent node via the direct route, receives the care-of address test request message; and

means that compares the care-of address in the care-of address test request message with the care-of address generated based on the address generation information transmitted with the home address test response message, and when agreement thereof is confirmed, transmits a care-of address test response message to the mobile node via the direct route.

Note here that although the above-described embodiment deals with the case including one mobile node, the mobile node may be a group of a plurality of nodes that can communicate in a close range. For instance, this may be the combination of a portable TV receiver and a mobile phone, so that the portable TV receiver and the mobile phone communicate with each other, thus conducting the procedure of the present invention as if they were one device.

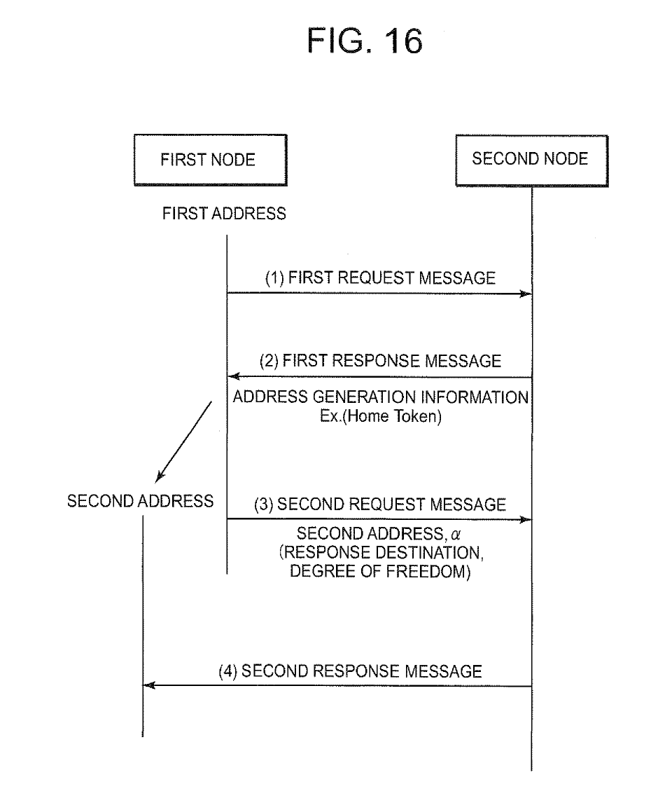

The above description deals with the case where Mobile IP route optimization is adapted to a one-way route. The present invention, however, is applicable to other cases as well. Referring to FIG. 16, the procedure therefor will be described below. Let that a request-side node (a first node) 101 and a response-side node (a second node) 102 communicate with each other. The request-side node 101 uses a specific address (a first address) to transmit and receive a message, thus conducting communication with the response-side node 102. During such a communication, the request-side node 101 wishes to conduct reception with a different new address (a second address). For instance, there is a case of wishing to receive using a digital broadcasting network, a satellite communication network or the like. In the route optimization of Mobile IP as one example, binding cache is set, and thereafter a new address is used for reception. As another usage, it can be considered that, since a message as a response is large in size, communication can be conducted more effectively when reception is conducted at another address of another interface. When it is desirable that a response message is returned to an address different from a source of a request message, if the request message including a response destination is transmitted and the responding node 102 transmits a response message in accordance with the request, such a transmission may be exploited as an attack as mentioned above concerning the problems.

In FIG. 16,

(1) The request-side node 101 wishes to receive a response at a new address, and the request-side node 101 transmits, to the response-side node 102, an address generation information request message (a first request message) to request address generation information, and

(2) the response-side node 102 receives the request for the address generation information and creates address generation information, and transmits an address generation information message (a first response message) as a response to the request-side node 101.

The address generation information is desirably unpredictable by the request-side node 101. That is, in the case of a predictable value, an attacker (the first node 101) conceivably determines a target and chooses a response-side node 102 that can generate an address with which the target can be attacked, and requests address generation information. To generate the address generation information using a secret key of the response-side node 102 is effective for making it difficult to predict the information. To generate it using nonce changing regularly is effective also for making it difficult to predict the information.

The response-side node (the second node) 102 may transmit address generation information not only in response to a request message but also for other reasons. For instance, in the case where an address (a second address) is changed regularly, it is more effective that the response-side node 102 transmits address generation information regularly than the request-side node 101 transmitting a request message every time of the change. Due to a reason of the response-side node 102, an address (a second address) at which a response is newly received may be changed. Further, in accordance with an instruction from another third node, an address (a second address) at which a response is newly received may be changed. Moreover, due to a change in network environment or in accordance with input information not from a node, address generation information may be transmitted.

(3) The request-side node (the first node) 101 receives the address generation information, and generates an address at which a response is received based on the address generation information. If required, that is, if there is a possibility of address duplication, confirmation is made whether the generated address has been already used or not by other terminals. If address duplication might occur, a degree of freedom is given. For instance, information of a is added, and a second address is generated as follows,

response destination address(a second address)=SHA1(address generation information,α).

If the response destination address requires a network prefix part, the network prefix part is added. In this case, a host identification part is generated using the address generation information.

The request-side node 101 includes the address (the second address) at which the generated response is received in a reply-to address request message (a second request message) and transmits the same to the response-side node (the second node) 102. This reply-to address request message includes information required to enable the response-side node 102 to generate response destination address from the address generation information. For instance, if information α is used to prevent duplications when the second address is generated, the message includes α. If a network prefix is added, the message includes a length of the network prefix and/or a value of the network prefix.

(4) The response-side node (the second node) 102 receives the reply-to address request message (the second request message), and if a new address (a second address) is designated as a destination of a response message, confirms whether the address can be generated from the address generation information. If required, information α and information on a network prefix are added to generate an address and make a comparison of the same.

The address generation information may be stored in the response-side node (the second node) 102. The address generation information may be included in the reply-to address request message (the second request message). In this respect, the response-side node 102 has to be able to confirm whether the address generation information is generated by itself. To this end, the response-side node 102 may store the address generation information therein. Alternatively, the address generation information may be generated using an address (first address) of the request-side node (the first node) 101. In this case, the address generation information can be generated from the source address (the first address) of the reply-to address message (the second request message). Instead of storing the address generation information, information used for the generation may be stored. For instance, if a secret key is used to generate the address generation information, the secret key may be stored. For another instance, when nonce is generated, and the nonce is used to generate the address generation information, the nonce may be stored. In the case of nonce, such nonce may be included in the address generation information message (the first response message) and be transmitted to the first node 101, and may be included in the reply-to address message (the second request message) for transmission. In this case, the response-side node 102 does not have to store a value of the nonce.

If it can be confirmed that the response destination address (the second address) can be generated from the address generation information, the response-side node 102 transmits a reply-to address response message (a second response message) to the address designated (the second address). That is, the response destination address (the second address) is not an address determined by the attacker (the first node 101) as a target, but an address generated from the address generation information generated by the response-side node (the second node) 102, and therefore there is little possibility of the reply-to address response message (the second response message) being exploited as an attack against a target.

If the address designated as the response destination address (the second address) cannot be generated from the address generation information, the message is discarded. Notification may be made about an error of the source address (the first address) of the request-side node (the first node) 101.

That is a description of the case other than adaptation of Mobile IP route optimization to one-way route.

Note that as for the above description and the case of adaptation of Mobile IP route optimization to one-way route, an address generation information request message (a first request message) corresponds to a HoTI message of Mobile IP, an address generation information message (a first response message) corresponds to a HoT message of Mobile IP, a reply-to address request message (a second request message) corresponds to a CoTIβ message of the present invention, and a response destination response message (a second response message) corresponds to a CoTβ message of the present invention.

### Embodiment 2

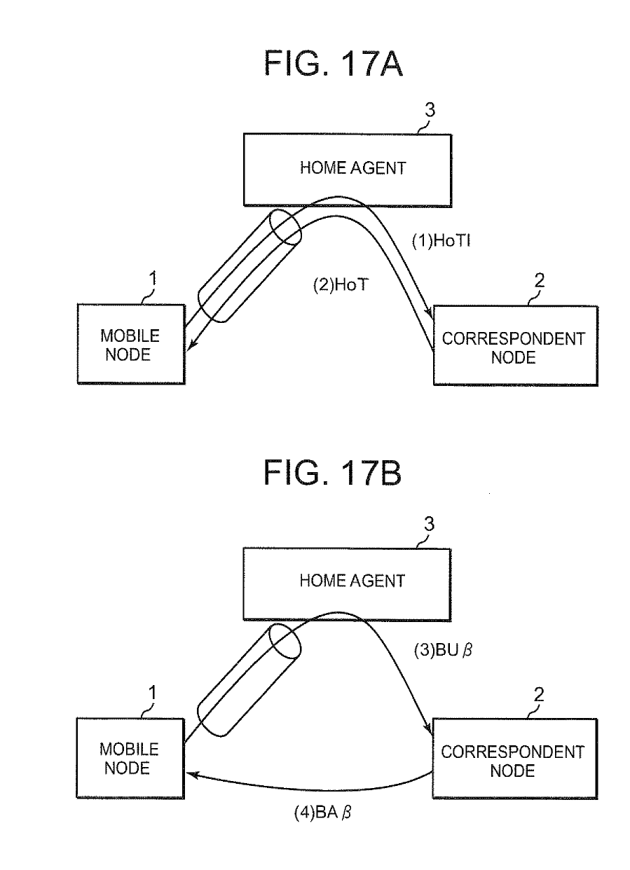

In Embodiment 1, as illustrated in FIG. 7(3), notification about the generated address CoA (Care-of Address) is conducted with a CoTIβ message. In Embodiment 2, however, CoTIβ/CoTβ messages are omitted, and notification about a generated address CoA is conducted with a binding update (BUβ) message. FIGS. 17A and 17B illustrate a home address test procedure and a BU procedure, respectively, in Embodiment 2 where a care-of address test procedure is omitted.

In the home address test procedure illustrated in FIG. 17A, similarly to Mobile P,

(1) a mobile node (MN) transmits a HoTI message with HoA being set as a source address to a correspondent node (CN) 2, and

(2) the correspondent node 2 transmits a HoT message to HoA.

The home address test procedure tells that the mobile node 1 transmits a message with HoA being set as a source and receives a response message at HoA.

In the BU procedure illustrated in FIG. 17B,

(3) the mobile node 1 transmits a BUR message with HoA being set as a source address to the correspondent node (CN) 2 via a home agent (HA) 3, and

(4) the correspondent node 2 transmits a BAβ message to CoA (direct route).

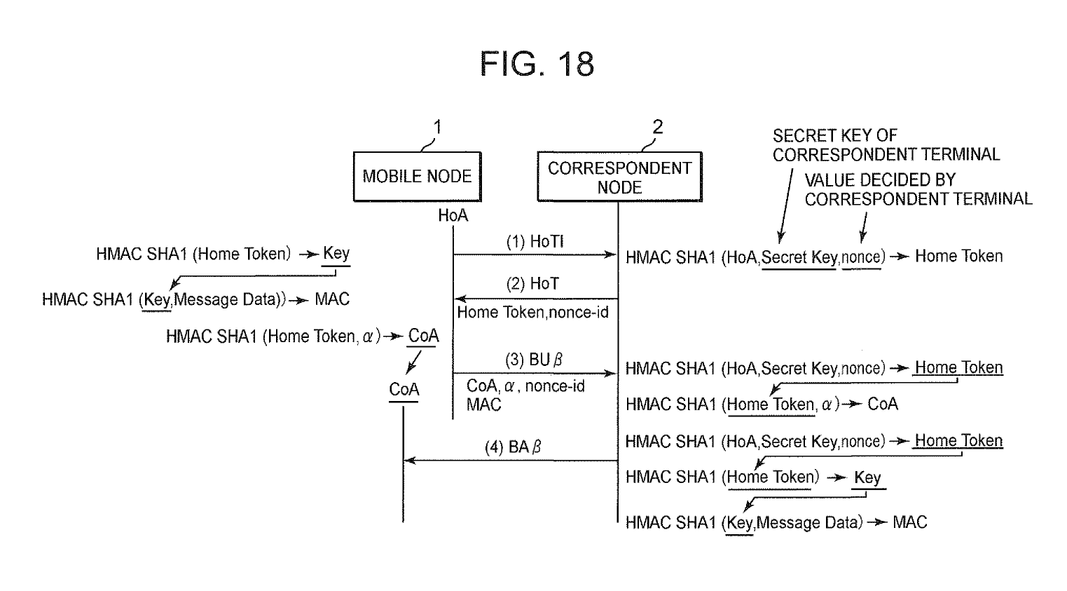

Next, referring to FIG. 18, message processing in Embodiment 2 will be described briefly below. Firstly, the mobile node 1 conducts a home address test procedure of Mobile IP. More specifically, the procedure is as follows.

<Home Address Test Procedure>

(1) The mobile node 1 transmits a HoTI message to the correspondent node 2, and

(2) the correspondent node 2 conducts a normal home address test procedure of Mobile IP. That is, using HoA (home address) as a source address of the HoTI message, a secret key (Kcn) of the correspondent node 2, and a nonce determined by the correspondent node 2, the correspondent node 2 conducts a Hash calculation by HMAC_SHA1 to find a Home Keygen Token (hereinafter called Home Token) as follows,

Home Token:=First(64,HMAC_SHA1(Kcn,(home address|nonce|0))).

The correspondent node 2 includes the calculated value of Home Token and identification information nonce-id to call nonce in a response message (HOT message) and transmits the same.

<CoA Generation>

Next, the mobile node 1 uses information included in the received HoT message to generate CoA. Since a region of a network prefix of the generated CoA cannot be changed, the mobile node 1 generates a region of host identification information other than that region using Home Token. If address duplication occurs because another host already uses the address, CoA (Care-of Address) is generated using data α to avert a collision of the address,

Care-of Address:=First(64,HMAC_SHA1(Home Token|α)).

<Binding Update Procedure>

(3) The mobile node 1 adds the generated CoA, the information α used for the CoA generation, nonce-id, and a message authentication code (MAC) to a BUβ message, and transmits the same to the correspondent node 2. To generate the MAC, a binding management key Kbm is generated as follows. Since α is used for CoA generation, Kbm is not the same value as CoA,

Kbm=HMAC_SHA1(Home Token).

To generate the message authentication code, a source address (home address) of the BUβ message, a destination address (correspondent node's address), message data (MH Data) and the generated key data (Kbm) are used,

MAC=First(96,HMAC_SHA1(Kbm,Mobility Data)),

Mobility Data=home address|correspondent|MH Data.

<CoA Confirmation and Binding Cache Setting>

Receiving the BUβ message, the correspondent node 2 firstly conducts a calculation of Home Token as follows. A nonce is called from nonce-id included in the BUβ message. Using the source address HoA of the BUβ message, the called nonce and a secret key (Kcn) of the correspondent node 2, Home Token is calculated,

Home Token:=First(64,HMAC_SHA1(Kcn,(home address|nonce|0))).

Further, using the generated Home Token and the information α included in the BUβ message, CoA (Care-of Address) is generated,

Care-of Address:=First(64,HMAC_SHA1(Home Token|α)).

If the generated CoA is equal to CoA included in the BUβ message, the correspondent node 2 judges that a response message can be transmitted to CoA.

Further, the correspondent node 2 confirms the message authentication code as follows. Firstly, key data (Kbm) is generated using the generated Home Token. Then, a message authentication code (MAC) is generated from the generated key data (Kbm) and message data (Mobility Data), which is compared with the authentication code included in the BUβ message,

Kbm=HMAC_SHA1(Home Token),

MAC=First(96,HMAC_SHA1(Kbm,Mobility Data)),

Mobility Data=home address|correspondent|MH Data.

Herein, the correspondent node 2 registers binding cache of a combination of HoA and CoA of the mobile node 1, but does not confirm whether transmission addressed to CoA does reach the mobile node 1 or not. Since the transmission to CoA does not lead to a reflection attack against a third terminal, the correspondent node 2 is not exploited as a steppingstone of an attack. Therefore, if the mobile node 1 sets CoA correctly and sets the same in a BUD message, then confirmation can be omitted whether transmission is made to CoA or not. Further, as for a risk of a HoT message being tapped by a malicious terminal, which then sets an unauthorized CoA to a BUβ message and transmits the same to a correspondent node 2, such a risk can be averted by preventing the tampering of a source address of the BUβ message or by configuring a network environment to prevent tapping. As a method to prevent the tampering of an address, a technique called ingress filtering is available that checks a source address at a router. A possible network that prevents tapping may include link layer encryption, authentication conducted at the time of network access, thus preventing unspecified terminals from connecting with the network or the like.

(4) The correspondent node 2 transmits, as a response to the BUβ message, a BAβ message.

That is a brief description of message processing with referent to FIG. 18. Referring next to FIGS. 14 and 15, operations of a correspondent node (response-side node) 2 and a mobile node (request-side node) 1 in Embodiment 2 are described below.

<Configuration of Correspondent Node (Response-Side Node)>

FIG. 14 is a block diagram illustrating a message processing unit of a correspondent node (response-side node) 2. The correspondent node 2 transmits and receives messages as follows,

(1) to receive a HoTI message and transmit a HoT message including CoA generation information (Home Token), and

(2) to receive a BUβ message to authenticate a message authentication code in the message and transmit a BAβ message.

A MIP BU/RR processing unit 13 (and a message reception unit 11 and a message transmission unit 12) conducts the message transmission/reception procedures of (1). A one-way BU/RR extension processing unit 13a (and the message reception unit 11 and the message transmission unit 12) conducts the message transmission/reception procedures of (2). In the case where a token and nonce-id are added to the message in the transmission procedure of HoT message, data is acquired from a Nonce management unit 14 and a Token generation unit 15. The Token generation unit 15 acquires a value of Nonce from the Nonce management unit 14, and calculates a value of Token based on an address acquired from the received request message and key data Kcn. The Nonce management unit 14 passes, to the MIP BU/RR processing unit 13, a value of Nonce ID corresponding to the value of Nonce passed to the Token management unit 14. The Token generation unit 15 generates Home token in response to a request for response destination address generation information from the request-side node 1, thus functioning as a response destination address generation information generation unit.

In the case where a confirmation procedure of a response destination address is conducted in the BUD message reception procedure, home nonce-id included in the BUD message is passed to the Nonce management unit 14, and a value of Nonce is acquired. The acquired value of Nonce and HoA as the source address of the BUβ message are passed to the Token generation unit 15, and a value of Token is acquired. The value of the acquired Token and information α included in the BUβ message are passed to a response destination address confirmation unit 20, a response destination address (CoA) is generated, and comparison is made whether the thus generated address agrees with the response destination address included in the BUβ message. The compared region is a region of a host identifier obtained by removing a network prefix region from the response destination address.

In the case where a message authentication code is created and confirmed (authenticated) in the BUβ message reception procedure, home nonce-id included in the BUβ message is passed to the Nonce management unit 14, and a value of the home nonce is acquired. The acquired value of Nonce and Home address included in the BUβ message are passed to the Token generation unit 15, and Home Token is generated. The thus acquired two tokens are passed to a Kbm generation unit 16, thus generating Kbm. The thus generated Kbm and the received message are passed to a message authentication code (MAC) confirmation unit 18 to calculate a value of MAC. Then, the calculated value is compared with a value of the MAC included in the BUβ message, thus checking whether they agree or not. If the checking of MAC succeeds, a correspondence between Home Address and Care-of Address is registered in a binding cache 19 (and a one-way RO extension unit 19a).

<Configuration of Mobile Node (Request-Side Node)>

FIG. 15 is a block diagram illustrating the configuration of a message processing unit of the mobile node (request-side node) 1. The mobile node 1 transmits and receives messages as follows,

(1) to transmit a HoTI message and receive a HoT message including CoA generation information (Home Token), and

(2) to generate CoA from CoA generation information (Home Token) and transmit a BUβ message including CoA and a message authentication code, and receive a BAβ message.

A MIP BU/RR processing unit 23 (and a message reception unit 21 and a message transmission unit 22) conducts the message transmission/reception procedures of (1). A one-way BU/RR extension processing unit 23a conducts the message transmission/reception procedures of (2). In the transmission procedure of the HoTI message, a value of Cookie generated by a Cookie generation unit 24 is inserted in the HoTI message. As for the Cookie included in the message, the correspondent node 2 is supposed to include the same value in a response message and return the same to the mobile node 1. Thereby, the mobile node 1 can associate the request message with the response message. A response destination address generation information request unit 29 makes a request by HoTI message transmission in (1), and a response destination address generation unit 30 generates CoA from CoA generation information (Home Token) in (3).

In the HoTI message transmission procedure, a procure to request Home Token corresponds to the procedure to request response destination address generation information (Home Token) from the response-side node 2, thus considering that the response destination address generation information request unit 29 exists. In the HoT message reception procedure, the mobile node 1 passes Home Token included in the HoT message to the response destination address generation unit 30 and generates a response destination address (CoA).

In the BUβ message transmission procedure, a response destination address created by the response destination address generation unit 30 and information a used for the response destination address generation are acquired, which are added to the BUβ message. In the BUβ message transmission procedure, Home Token acquired from the received HoT message is passed to a Kbm generation unit 25, thus generating Kbm. Further, the BUβ message to be transmitted and the generated Kbm are passed to a message authentication code generation unit 26, thus generating a message authentication code. The generated message authentication code is added to the BUβ message for transmission. A Binding Cache management unit 27 (and a one-way RO extension unit 28) manages the Binding Cache 19 of the correspondent node 2.

Note that each functional block used in the descriptions of the above-stated embodiments may be typically implemented as a LSI that is an integrated circuit. These blocks may be individually configured as one chip, or one chip may include a part or all of the functional blocks. LSIs may be called an IC, a system LSI, a super LSI, and an ultra LSI depending on the degree of integration. A technique for integrated circuit is not limited to LSI, but an integrated circuit may be achieved using a dedicated circuit or a general-purpose processor. After manufacturing a LSI, a FPGA (Field Programmable Gate Array) capable of programming and a reconfigurable processor capable of reconfiguring connection and setting of a circuit cell inside a LSI may be used. Further, if a technique for integrated circuit that replaces LSIs becomes available by the development of a semiconductor technique or derived techniques, functional blocks may be naturally integrated using such a technique. For instance, biotechnology may be applied thereto.

### INDUSTRIAL APPLICABILITY

The present invention is applicable so as to allow a transmission-end of data and a message to confirm a destination address in a transmission request from a reception-end so as to prevent an attack by a transmission request from an unauthorized third person. The present invention is further applicable to a return routability procedure to implement route optimization while keeping the same level of safety as in the conventional techniques even in a one-way route and an asymmetric route.

1-13. (canceled)

14. An address generation method, comprising the steps of:
a step where a second node transmits, to a first node, address generation information allowing the first node to generate a new address;
a step where the first node generates the address of the first node based on the address generation information received from the second node and transmits the same to the second node; and
a step where the second node compares the address of the first node received from the first node with an address generated based on the address generation information transmitted to the first node.

15. The address generation method according to claim 14, wherein
the first and the second nodes are a mobile node and a correspondent node thereof, respectively, and
the address of the first node is a care-of address of the mobile node,
further comprising a step of carrying out route optimization between the mobile node and the correspondent node.

16. The address generation method according to claim 15, wherein the address generation information is home token included in a home address test response message transmitted from the correspondent node to the mobile node in the route optimization step.

17. An address generation system, comprising:
a unit adapted so that a second node transmits, to a first node, address generation information allowing the first node to generate a new address;
a unit adapted so that the first node generates the address of the first node based on the address generation information received from the second node and transmits the same to the second node; and
a unit adapted so that the second node compares the address of the first node received from the first node with an address generated based on the address generation information transmitted to the first node.

18. A node, comprising:
a unit that receives address generation information to generate a new address from a correspondent node; and
a unit that generates the address based on the address generation information, and transmits, to the correspondent node, information enabling comparison of the address with an address generated by the correspondent node based on the address generation information.

19. A correspondent node, comprising:
a unit that transmits, to a node on one end, address generation information to generate a new address of the node on one end; and
a unit that, when the node on one end generates an address of the node on one end based on the address generation information, receives the address and compares the same with an address generated based on the address generation information transmitted to the node on one end.

20. A communication method, comprising the steps of:
an address generation information transmission step where a second node creates address generation information to generate a second address of a first node, and transmits an address generation information message including the address generation information to a first address of the first node;
a reply-to address request message transmission step where the first node generates the second address based on the address generation information in the address generation information message, and transmits a reply-to address request message from the first address to the second node, the reply-to address request message designating the second address as a response message destination; and
a reply-to address response message transmission step where the second node receives the reply-to address request message, compares the second address in the reply-to address request message with an address generated based on the address generation information, and transmits a reply-to address response message to the second address of the first node.

21. The communication method according to claim 20, wherein the address generation information is generated from secret information that the second node only keeps and a random value that the second node generates at regular intervals.

22. The communication method according to claim 21, wherein the address generation information is home token used for a binding procedure conducted for route optimization in Mobile IP.

23. The communication method according to claim 20, wherein the second address is an address for a one-way route that is exclusively used for reception from the first node.

24. A communication system, comprising:
an address generation information transmission unit adapted so that a second node creates address generation information to generate a second address of a first node, and transmits an address generation information message including the address generation information to a first address of the first node;
a reply-to address request message transmission unit adapted so that the first node generates the second address based on the address generation information in the address generation information message, and transmits a reply-to address request message from the first address to the second node, the reply-to address request message designating the second address as a response message destination; and
a reply-to address response message transmission unit adapted so that the second node receives the reply-to address request message, compares the second address in the reply-to address request message with an address generated based on the address generation information, and transmits a reply-to address response message to the second address of the first node.

25. A node comprising:
a unit that receives an address generation information message transmitted to a first address, the address generation information message including address generation information that a correspondent node creates to generate a second address;
a unit that generates the second address based on the address generation information in the received address generation information message, and transmits a reply-to address request message from the first address to the correspondent node, the reply-to address request message designating the second address as a response destination; and
a unit that, when the correspondent node compares the second address in the reply-to address request message with an address generated based on the address generation information and transmits a reply-to address response message to the second address, receives the reply-to address response message.

26. A correspondent node comprising:
a unit that creates address generation information to generate a second address of a node on one end, and transmits an address generation information message including the address generation information to a first address of the node on one end,
a unit that receives, when the node on one end receiving the address generation information message generates the second address based on the address generation information in the address generation information message and transmits a reply-to address request message that designates the second address as a response destination, receives the reply-to address request message; and
a unit that receives the reply-to address request message, compares the second address in the reply-to address request message with an address generated based on the address generation information, and transmits a reply-to address response message to the second address of the node.
